(19) United States
(12) Patent Application Publication
(10) Pub. No.: US 2004/0261620 A1
(43) Pub. Date: Dec. 30, 2004

(54) High energy field air purifier

(76) Inventor: George Thompson, Lakeland, FL (US)

Correspondence Address: PEACOCK MYERS AND ADAMS P C, P O BOX 26927, ALBUQUERQUE, NM, 871256927

(21) Appl. No.: 10/864,166

(22) Filed: Jun. 9, 2004

Related U.S. Application Data
(63) Continuation-in-part of application No. PCT/US04/16832, filed on May 28, 2004.
(60) Provisional application No. 60/477,316, filed on Jun. 9, 2003.
(60) Provisional application No. 60/474,006, filed on May 28, 2003.

(51) Int. Cl. B03C 3/38

(52) U.S. Cl. 96/16

(57) ABSTRACT

An apparatus and method for sterilizing airborne pathogens and reducing airborne pollutants in air for buildings, aircraft, or other structures. The apparatus is capable of high air flows and is optionally integrated with an efficient air heating/cooling system. High fields are produces by a static, preferably infrared, field combined with a high intensity microwave field. This combination allows fields to develop that are high enough in intensity to kill pathogens and dissociate contaminant molecules and other pollutants. The heat produced by the field generators is optionally used to operate an absorption chiller to cool and dehumidify, or alternatively heat, the sterilized air before it is returned to the building or structure. Also a method and apparatus for vehicle emissions control, providing significant pollutant reductions in vehicle exhaust without significantly heating the exhaust and with very low backpressures.

### CROSS-REFERENCE TO RELATED APPLICATIONS

This application claims the benefit of the filing of U.S. Provisional Patent Application Ser. No. 60/477,316, entitled “High Energy Field Quantum Air Sterilizer”, filed on Jun. 9, 2003, and is a continuation-in-part of U.S. Patent Application Attorney Docket No. 31243-UT, entitled “Combined High Energy Field Air Sterilizer And Absorption Chiller/Cooler”, filed on May 28, 2004, which claims the benefit of the filing of U.S. Provisional Patent Application Ser. No. 60/474,006, entitled “Combined High Energy Field Hybrid Air Sterilizer and Absorption Chiller”, filed on May 28, 2003, and U.S. Provisional Patent Application Ser. No. 60/477,316, entitled “High Energy Field Quantum Air Sterilizer”, filed on Jun. 9, 2003. This application is also a continuation-in-part of PCT Application Ser. No. PCT/US04/16832, entitled “Combined High Energy Field Air Sterilizer And Absorption Chiller/Cooler”, filed on May 28, 2004. The specifications and claims of all these applications are incorporated herein by reference.

### BACKGROUND OF THE INVENTION

1. Field of the Invention (Technical Field)

The present invention relates to a method and apparatus for purifying high volumes of air, including controlling emissions from combustion exhaust and sterilizing pathogens in air for buildings. The invention optionally provides for efficient heating or cooling and dehumidification.

2. Background Art

Note that the following discussion is given for more complete background of the scientific principles and is not to be construed as an admission that such concepts or publications listed are prior art for patentability determination purposes.

The need for cost effective air quality improvement that can be used in new construction or existing heating cooling and ventilation equipment systems is seen in almost every level of public and private dwellings in modern society. Schools, hospitals, doctors' offices, airports, office buildings, sports and events stadiums are all places where people interact enabling disease to be spread through the air or by contact or close contact. The ability to eliminate airborne pathogens like Legionnaire's disease, micro-bacterium tuberculosis, hepatitis and influenza and SARS with cost effective air sterilization and optional humidity control in a single high volume heating, cooling and ventilation package that is easily installed and maintained will reduce healthcare costs and lost productivity from sickness caused by airborne contamination. The use of antibiotics by the agricultural industries worldwide for disease control in milk and meat production increases the threat of highly contagious diseases entering our populations that may be resistant to treatment by current or future antibiotics. Applications which benefit from destroying airborne pathogens include pharmaceuticals, food processing, water filtration, public buildings, hospitals, microelectronics manufacturing, biotechnology, breweries, food sterilization, clean rooms, greenhouses, isolation rooms, airports, aircraft, HVAC air-handling, bioremediation, livestock barns and bio-security.

In addition, airborne inorganic and organic pollutants such as carbon monoxide and volatile organic compounds (VOCs), including hexane, dihydrofuran, benzene, and methyl acetate, are prevalent in most buildings, airplanes, and other enclosed or semi-enclosed structures, causing illness and lowering worker productivity. Thus there is a need for a high air flow device to simultaneously reduce or eliminate both airborne pathogens, including resistant strains, and contaminants such as VOCs for buildings, while optionally simultaneously providing energy efficient temperature and humidity control.

There is also a need for an efficient method an apparatus for destroying pollutants that are contained in exhaust from internal combustion engines. Such an apparatus must be compatible with vehicle operating parameters, including temperature, pressure, flow rate, and contaminant concentrations, and must be light, compact, and power efficient. The apparatus should be adaptable to scrub pollutants from other combustion sources, such as smokestacks.

The U.S. Food and Drug Administration's Center for Food Safety and Applied Nutrition compiled a summary of current knowledge in alternative food processing technologies, entitled Kinetics of Microbial Inactivation for Alternative Food Processing Technologies (published Jun. 2, 2000, available online at http://vm.cfsan.fda.gov/˜comm/ift-toc.html). A number of references cited therein, including Hülsheger, H. and Nieman, E. G. (1980), “Lethal effect of high-voltage pulses on e. coli K12”, Radiat. Environ. Biophys. 18(4):281-8, and Peleg, M. (1995), “A model of microbial survival after exposure to pulse electric fields”, J. Sci. Food Agric. 67(1):93-99, discuss models of microorganism inactivation by application of pulsed electric fields. They show that a field of about 20 KV/cm is required to sterilize pathogens. However, they do not disclose a method of generating the necessary high fields to accomplish this. The above references are incorporated herein by reference.

Methods for removing NOx from exhaust streams using microwave-induced plasmas are well known in the art; see for example U.S. Pat. Nos. 5,782,085 and 6,422,002, incorporated herein by reference. However, these methods are generally unstable due to boundary displacement, and plasma conditions are notoriously difficult to maintain in real-world conditions. Furthermore, it is difficult for them to treat high flow rates of exhaust or air, in part because the process depends on ionic mobility, which is much slower than electronic mobility. Plasmas also have difficulty treating mixtures of gases. They also require the use of expensive gases to prevent spark breakdown.

Guan Penghui, et al., at the 8^{th} International Symposium on High Pressure Low Temperature Plasma Chemistry, Jul. 21-25, 2002, presented a method for reducing NO in a nitrogen gas stream by inducing a non-thermal plasma. However, like most other related plasma-based pollutant removal methods, it requires high pressures, making it incompatible with most combustion processes, and even with low flow rates can only achieve reduction rates of less than 60%. Because the pulse rate is relatively low, higher reduction rates will not be possible due to recombination and other processes occurring between pulses. This also means that only low flow rates can be accommodated, so practical use with vehicles would be impossible. Furthermore, the efficiency would decrease in real world applications for which the combustion exhaust includes oxygen, such as internal combustion engines, because of conversion of the oxygen to ozone, which will reduce the achieved electric field. Therefore there exists a need for a method and apparatus to reduce pollutants such as NOx in exhaust gases which doesn't suffer from the foregoing deficiencies.

### SUMMARY OF THE INVENTION (DISCLOSURE OF THE INVENTION)

The present invention is an apparatus for sterilizing air which comprises a static field generator, two or more microwave generators preferably comprising magnetrons, a sterilization cavity, and an optional air temperature control system, wherein the air temperature control system is heated by the static field generator and the microwave generators and a superposition of electric fields produced by the microwave generators is modulated in order to produce high electric fields in air flowing within the cavity. The static field generator preferably comprises an infrared generator, which preferably comprises one or more quartz tubes. The tubes may be turned on or off independently. A combined field density of between approximately 9 watts per cubic centimeter and approximately 13 watts per cubic centimeter, including approximately 13 watts per cubic centimeter, is created in the air. The two or more microwave generators are preferably situated so that magnetic fields produced by the generators cancel each other out within the cavity. They apparatus can sterilize large volumes of air flowing through the cavity, at a rate of up to approximately 250,000 cubic feet per minute (CFM). A pathogen or contaminant in the air preferably flows through the cavity in no less than approximately six milliseconds. The air temperature control system preferably comprises an absorption chiller, which preferably comprises a coolant selected from the group consisting of ammonia and lithium bromide. The air temperature control system preferably heats, cools, or dehumidifies the air.

The present invention is also a method of sterilizing air comprising the steps of applying a static field, preferably an infrared field, and two or more modulated microwave fields to the air, optionally transferring excess heat to an air temperature control system, and optionally varying a temperature of the air. Modulation of the microwave fields preferably produces a combined field density of between approximately 9 watts per cubic centimeter and approximately 13 watts per cubic centimeter, including approximately 13 watts per cubic centimeter, in the air. The air temperature control system preferably comprises an absorption chiller. The varying step preferably comprises heating, cooling or dehumidifying the air, which preferably is flowing at a rate of up to approximately 250,000 CFM.

The present invention is also an apparatus for reducing pollutant concentrations in a gas comprising a static field generator, two or more microwave generators, and a cavity, wherein a combination of electric fields produced by the microwave generators and the static field generator produces high electric fields in the gas flowing within the cavity. The static field generator preferably comprises an infrared generator which preferably comprises one or more quartz tubes, wherein power provided to each of the tubes is preferably independently controllable. A combined field density of between approximately 9 watts per cubic centimeter and approximately 13 watts per cubic centimeter is preferably created in the gas. Alternatively, a combined field density of approximately 13 watts per cubic centimeter is created in the gas. An electric field having a value of approximately 20 KV/cm is preferably created in the gas. The microwave generators preferably comprise magnetrons and are preferably situated so that magnetic fields produced by the generators cancel each other out within the cavity. The microwave generators preferably comprise field stabilizers, each preferably comprising at least one spark gap. Each microwave generator preferably comprises an asymmetrical anode which preferably controls a Hermstein sheath corona discharge.

A pollutant in the gas preferably flows through the cavity in no less than approximately six milliseconds. The gas optionally comprises air, which preferably flows through the apparatus at a rate of between approximately 27,000 CFM and approximately 250,000 CFM. Alternatively the gas comprises combustion exhaust, and the apparatus preferably comprises a vehicle. The exhaust preferably flows through the cavity at substantially the same the exhaust flow rate of the exhaust exiting the exhaust manifold of the vehicle, with a backpressure of less than approximately two inches of water column to the exhaust manifold.

The present invention is further a method of reducing pollutant concentrations in a gas comprising the step of applying a static field, preferably an infrared field, and two or more microwave fields to the gas. The combined field density is preferably between approximately 9 watts per cubic centimeter and approximately 13 watts per cubic centimeter in the gas, or alternatively approximately 13 watts per cubic centimeter in the gas. An electric field with a value of approximately 20 KV/cm is preferably created in the gas. The method preferably comprises canceling out magnetic components of the two or more microwave fields. At least one Hermstein sheath corona discharge is preferably created. The fields are applied to a pollutant in the gas for at least approximately six milliseconds. The gas optionally comprises air, which flows through the fields at a flow rate of preferably between approximately 27,000 CFM and approximately 250,000 CFM. Alternatively the gas comprises combustion exhaust, and the method provides a backpressure to the incoming exhaust of less than approximately two inches of water column.

An object of the present invention is to provide an energy-efficient, high volume air sterilizer, optionally combined with a cooler/heater, having low capital and operating costs, and having greater durability than compressor style refrigeration units using refrigerants that can harm the environment.

An additional object of the present invention is to provide an efficient, high flow apparatus for vehicle emissions control.

A further object of the present invention is to provide reduction in pollutants in combustion exhaust.

An advantage of the present invention is its safe, efficient all electric design.

A further advantage is that the staged variable load capacity of the present invention can easily match the HVAC requirements of a facility, including built-in humidity control.

Yet a further advantage is the modular design and small footprint of the present invention, which allow for semi-portable applications since the unit is totally self-contained. Multiple units can be added to serve a wide range of building loads and even increase reliability.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a schematic of the combined high energy field air sterilizer/absorption chiller/heater of the present invention;

FIG. 2 is a schematic of the vehicle emissions control embodiment of the present invention, including an inset depicting Section AA.

### DESCRIPTION OF THE PREFERRED EMBODIMENTS (BEST MODES FOR CARRYING OUT THE INVENTION)

The present invention is a combined high energy field hybrid air cleaner, sterilizer and absorption chiller/heater for use with buildings or other structures.

As used throughout the specification and claims, the term “pathogen” means microbe, mircoorganism, germ, virus, bacterium, allergen, fungus, pollen, spore, mildew, mold, protozoa, cyst, parasite, and the like.

As used throughout the specification and claims, the terms “contaminants” or “pollutants” mean organic or inorganic compounds such as VOCs, oil mist, NOx and other nitrogen oxides, carbon monoxide, carbon dioxide, sulfur oxides, ozone, particulates, soot, smoke, and the like.

As used throughout the specification and claims, the term “sterilize” and variants thereof mean to render a majority of pathogens inactive, as well as to significantly reduce the concentration of pollutants and/or contaminants (including but not limited to VOCs), and the like.

The present invention requires the convolution of at least two high energy fields. The sterilization cavity is preferably tuned to excite and dissociate pi bonds, at least one of which is present in all double and triple bonds, such as those found in carbon/hydrogen and nitrogen compounds. Air passing through the system is exposed to a static, preferably infrared (IR) field in addition to preferably at least two pulsed fields, preferably in the microwave range. A UV field, or fields of other wavelengths, may be used instead of the IR field. This convolution dramatically increases the intensity of the field, thus producing excited molecular events resulting in sterilization of the pathogens in the air, as well as dissociation of contaminants. Specifically, high intensity slow microwaves excite the contaminant molecules and pathogens, which ordinarily would reemit heat (which is the normal operation of a microwave oven). The static IR field suppresses this thermal reemission, forcing molecular structures past the continuum energy level. Photo-ionization occurs, freeing electrons which in the convolved fields form an avalanche pulse, resulting in an electric field with a high enough intensity to dissociate contaminant molecules. This pulse modulates the microwave field. The avalanche pulses preferably have a rise time of approximately 20 ns to 30 ns, and the pulse width is preferably approximately 5 ns, or alternatively up to the pulse width of the microwave, or about 20 ns, depending on air flow. The pulse frequency depends on the impedance of the sterilization cavity, which depends on the constituents of the air in the cavity. Typical pulse frequencies range up to 10⁷ Hz. Pulse width, rise time and electric field intensity determine how long a particular particles needs to be in the cavity before inactivation occurs. The desirable outcome is sterilized air at large volume and velocity. Note that unlike other microwave-driven emissions devices, the present invention does not produce a plasma, and is capable of operating at ambient pressure.

The combined fields sterilize resistant strains of pathogens because cell structures are deeply penetrated by the fields, resulting in irreversible thermal molecular and cell expansion by as much as 400%. This produces a pathogen reduction between approximately 99.9% and 99.999%. A combined field density of from approximately 9 watts per cubic centimeter to about 13 watts per cubic centimeter, i.e. up to approximately 11 eV, is required to dissociate contaminants such as VOCs, NOx, and CO; approximately 13 watts per cubic centimeter is required to sterilize pathogens. These field levels can be achieved by adjusting the power of each of the fields. For example, a 10 kW microwave power convolved with the infrared field strength disclosed herein will provide the necessary field density to achieve sterilization. Another benefit of these high fields is that particulates are reduced to dry ash.

The advantage of using the high-energy convolved fields of the present invention is complete, efficient sterilization of an air stream without significant heating of the actual flow. The irreversible nature of pi bond dissociation assures that exiting pathogens cannot become active after treatment. The photo-ionization process of the present invention results in a spatial distribution of electrons which may be visualized as an oscillating electron wind. The magnitude and density of the oscillations, which can be thought of a series of electron avalanche pulses, partly determine how successful the sterilization process will be. Note that the lower the conductivity, the more efficient the pulses are at breaking pi bonds, since higher electric field potentials are allowed to build up within the amplified cavity. The oscillations show a slow wave effect, similar to that known in MASERS. A preferred design rule is that pathogens or pollutants are to remain a minimum of approximately 6 milliseconds within the cavity to ensure complete sterilization.

The more pulses that can be produced per transport time, i.e. the faster the rise times and the shorter the peak-to-peak pulse waveform, decreases the effects of medium conductivity and the possibility of field breakdown by not allowing electrons time to disperse before the onset of the next pulse. This is provided by a highly stressed positive or negative asymmetrical electrode. The resulting onset of a Hermstein glow resulting from this condition and the control of the pre-onset corona determine the final electric field potential in the areas where the photo-ionization takes place in the cavity. Higher pulse frequencies combined with the Hermstein sheath corona formation can produce as many as 10¹⁰ molecular reactions per second at fairly low ambient temperatures (from 20-40° C.). The Hermstein glow preferably forms around a highly stressed anode, in which a negative ion space charge cloud creates a high anode potential drop, akin to the cathode fall produced by the positive ion in the common cathode glow discharge. If the presence of the Hermstein glow is maintained, the sparking potential of an asymmetrical gap can be raised by several orders of magnitude. The present invention is designed to promote the Hermstein sheath to maintain high potentials in the convolved fields, preferably above the 20 KV/cm, or 13 watts per cubic centimeter, sterilization/dissociation level.

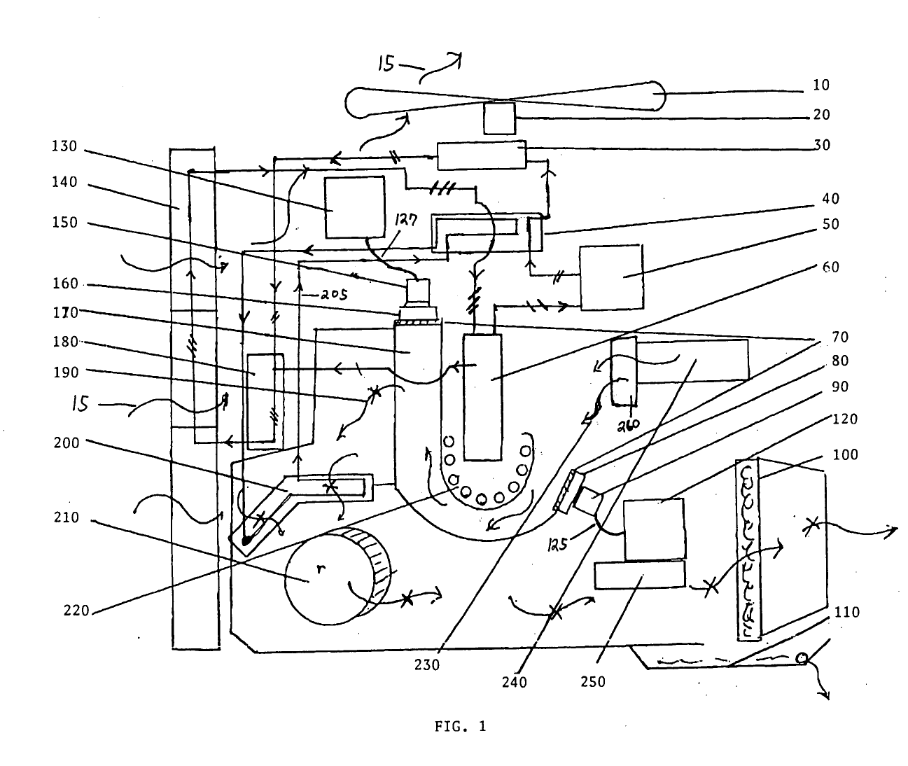

FIG. 1 is a schematic depiction of a preferred embodiment of the present invention. Outside air and/or return air from the building enters the apparatus through duct 240, and preferably passes through pre-filter 260 which filters out all particulates over approximately 150 microns. Alternatively, filters with other particulate size ratings may be employed. Air 230 then passes to air sterilization cavity 170 comprising a static infrared radiation field generator, preferably comprising infrared quartz tube array 220 which preferably surrounds the bottom portion of absorption generator 60 and transfers the IR energy to air 230. Gold plated quartz tube elements are preferably utilized due to their long life and easy replacement. In a preferred embodiment twelve tubes are arrayed along the cavity, spaced evenly. It is preferable to use 900 watt single element tubes, thus providing a field of 10.8 KVA, having a temperature range up to 145° C. each; alternatively, 1500 watt dual element tubes may be used if higher fields are desired. Thus temperatures up to 1700° C., or higher if desired, may be reached in the cavity. However, due to rapid air flow the temperature of the air passing through the cavity rises less than or equal to only about 10-15° C. from inlet duct 240 to the cavity exit. A high density infrared field (95% efficient) is preferable to insure decontamination. Any frequency radiation, such as ultraviolet, may be used instead of infrared radiation, as long as the field is substantially static or constant in intensity. Applying a static field to air 230 has the additional advantage of rendering water vapor in air 230 transparent to microwave radiation; that is, preventing thermal reemission and thereby increasing efficiency.

Air 230 is also treated with microwave radiation produced by at least one permanent magnet type magnetron. Preferably two magnetrons 90, 150 are employed along cavity 170. Their relative locations are preferably chosen so that the produced electric fields superpose but the magnetic fields cancel out. (Coupled magnetic fields would limit the attainable maximum superposed electric fields.) Thus the electric field in cavity 170 is maximized, forming maser-like standing or slow waves in cavity 170 without requiring a tuned cavity. If more power is required, more magnetrons may be employed. Although any frequency may be used in the practice of the present invention, as a practical matter regulatory issues currently limit the possible frequencies to only a few. Which frequency is chosen depends on the required airflow. To accommodate more airflow cavity 170 must be larger, thus the microwave wavelength must be longer to efficiently couple microwave energy into cavity 170. In addition to satisfying air flow requirements, the size of the cavity is chosen to ensure that transit time of air 230 through cavity 170 is preferably no less than 6 milliseconds, which is the minimum time for most pathogens and contaminants to absorb the radiation and thus be sterilized and/or dissociated. This time may be increased for complex pathogens such as pollen and mold, or decreased for other pathogens or compounds. Table 1 summarizes this relationship.

TABLE 1

| | Approx. Cavity | Microwave |
|---|---|---|
| Air Flow (CFM) | Diameter (cm) | Frequency (GHz) |
| 250,000 | 117 | 0.915 |
| 27,000 | 22 | 2.45 |
| 3,000 | 6 | 5.8 |
| 150 | 1 | 24.125 |

The microwave radiation section preferably comprises a low air restriction cavity design. The exposure of the air 230 to microwaves may occur before, after, and/or substantially simultaneously with the application of the infrared radiation. Magnetrons 90, 150 are powered by back plates 120, 130 via high voltage lines 125, 127 and preferably couple to cavity 170 via waveguides 80, 160, which are impedance matched to cavity 170. Borosilicate hot mirrors 70, which are transparent to microwave radiation, are preferably installed to prevent heat from cavity 170 from affecting magnetrons 90, 150. Tuning of coupled microwaves by stub tuners is preferred, although any tuning method may be used. Optional instant on/off operation allows for efficient and safe operation, as do optional safety interlocks to defeat the field if access covers to the microwave cavity are opened. The system is controlled and monitored via processor 250. Each magnetron preferably requires a power of 800 to 1000 watts, which provides cost effective operation.

Sterilized air 190 optionally passes from cavity 170 over or through an infrared concentration grid (not pictured) if a desired air flow increase reduces the time air 190 has spent in cavity 170 to less than approximately six milliseconds. Air 190 then passes over coils 200 containing chilled water, thus both cooling and condensing moisture in air 190. The chilled water is preferably provided by an absorption chiller system, such as those known in the art, which takes advantage of heat produced by the air sterilization system. Other refrigeration systems may alternatively be used. Excess heat from both the infrared quartz tubes and the microwave units heats generator 60. By using heat that would otherwise be wasted, system efficiency is dramatically increased. (The actual efficiency of heat transfer from the microwave units will depend on the air density during operation.) Generator 60 contains at least one coolant mixture, preferably comprising liquid ammonia such as R-717, or alternatively lithium bromide; however, the mixture may comprise any coolant known in the art. Preferably the coolant is mixed with water to form a mixture comprising one-third coolant and two-thirds water. R-717 is preferred when dehumidification is a high level requirement, since ammonia units can reach colder chiller temperatures. When using ammonia as the coolant, chilled water in coils 200 is sufficient to cool air 109 to 42° F. Otherwise, features of ammonia based systems are similar to those of lithium bromide chillers.

The coolant mixture is heated in generator 60, causing the mixture to separate. Pump 50 pumps the liquid coolant from generator 60 to absorber 40, while the differential pressure in the system drives the water remaining in generator 60 to preabsorber 180. In absorber 40, which functions as a heat exchanger, hot water circulated from coils 200 is cooled by evaporation of the liquid ammonia. This chilled water then is circulated through self-contained chilled water system 205 to coils 200 which cool air 190. The resulting warmed water is circulated back to absorber 40. The chilled water preferably comprises ethylene glycol which protects against freezing and helps prevent corrosion. The gaseous ammonia optionally circulates to heat exchanger 30 which lowers its temperature with cooling air 15 circulated by condenser fan 10, thus utilizing more of the available cooling air, thereby increasing efficiency of the system. The ammonia then circulates to preabsorber 180 which preferably comprises a cooling coil from condenser 140, where the ammonia is precooled so it may be more efficiently absorbed back into the water which came from generator 60. Then the mixture proceeds to condenser 140 where it is cooled further by cooling air 15 circulated by condenser fan 10 powered by motor 20, and then is circulated back to generator 60. Condenser 140 typically requires approximately 6000 SCFM of air flow provided by condenser fan 10, which is preferably adjustable based on outside ambient conditions. Pump 50 may optionally be located between condenser 140 and generator 60.

Air 190 is discharged out of the present apparatus and returned into the building intake duct by fan 210. In addition to cooling the air, dehumidification is also provided, both by condensation occurring as air 190 passes over chilled water coils 200 but also optionally as air 190 passes through a standard dehumidification impact pad 100 on its way to being discharged into the building. Pad 100, which is preferably comprised of stainless steel, rapidly removes moisture droplets from air 190, and the droplets preferably collect in drip pan 110, which optionally comprises a drain. Dehumidification is efficient enough so that relative humidity of air discharged to the building return is approximately 40% when the ambient relative humidity is 70% or greater. Return air can be controlled to full or partial vent or makeup. The absorption chiller preferably uses a staged infrared power input to provide dehumidification and cooling over a wide ambient temperature range. That is, when cooling needs are reduced, some of the quartz IR elements may be individually turned off, resulting in greater energy savings than currently used units, which can only be cycled completely on or completely off. In cold weather, heating the air is also possible by preventing evaporation of the ammonia in absorber 40. In this case, the hot liquid ammonia in absorber 40 heats the water, which then circulates to coils 200 and heats air 190. In addition, as discussed above, air 190 exiting cavity 170 has already been heated by up to about ten degrees over the temperature of inlet air 230. The present invention has the advantages of high efficiency and stable chiller operation even at extreme temperatures of −12° C. to +45° C. for chiller operation and −20° C. for heating cycles.

Although this embodiment has been described and pictured as including a heating/cooling/dehumidification system, the inclusion of such a system is optional.

The total system is currently designed for total electric operation and is mounted outside for proper condenser air flow with duct access available for discharge and return air application. In order to improve energy efficiency, the operation of the combined fields can be programmed to reduce energy consumption once the air in the building has been recirculated enough so that the pathogen and contaminant concentration of the air has been reduced to the desired level. For example, some of the quartz tubes may be turned off. An advantage of the design of the present invention is that semi-portable wheel around or roller type embodiments with an air flow capacity in the 1500-10,000 CFM range can be used to quickly control air contaminants where existing air systems are inadequate. Multiple units of the present invention may be arrayed for use in intermediate and large mechanical systems requiring hundreds of tons of air capacity.

Another preferred embodiment of the present invention is an apparatus for reducing pollutants in combustion exhaust, including but not limited to vehicle exhaust. The apparatus of this embodiment is preferably a part of the vehicle producing the exhaust. The reactor cavity has been designed to increase the concentration of particulate and exhaust emissions in the cavity and limit diffusion within the exhaust stream. The reactor cavity length and the transient velocity of the exhaust gases work together to reduce deposits and increase reaction efficiency. The low restriction design, applying a maximum backpressure of preferably only two inches of water column, enables the technology to be applied to virtually all existing engines, including but not limited to both diesel and gasoline engines, and combustion turbines. As a non-limiting example of operating conditions suitable for the present invention, typical automotive class diesel engines up to 600 horsepower have exhaust gas volumes ranging from about 268 to 2200 CFM. Exhaust gas temperatures range from about 120° F. to 960° F., with a free oxygen content of approximately 7-8%. Operation of the apparatus of this preferred embodiment is similar to that of the above embodiment, but without the cooling section.

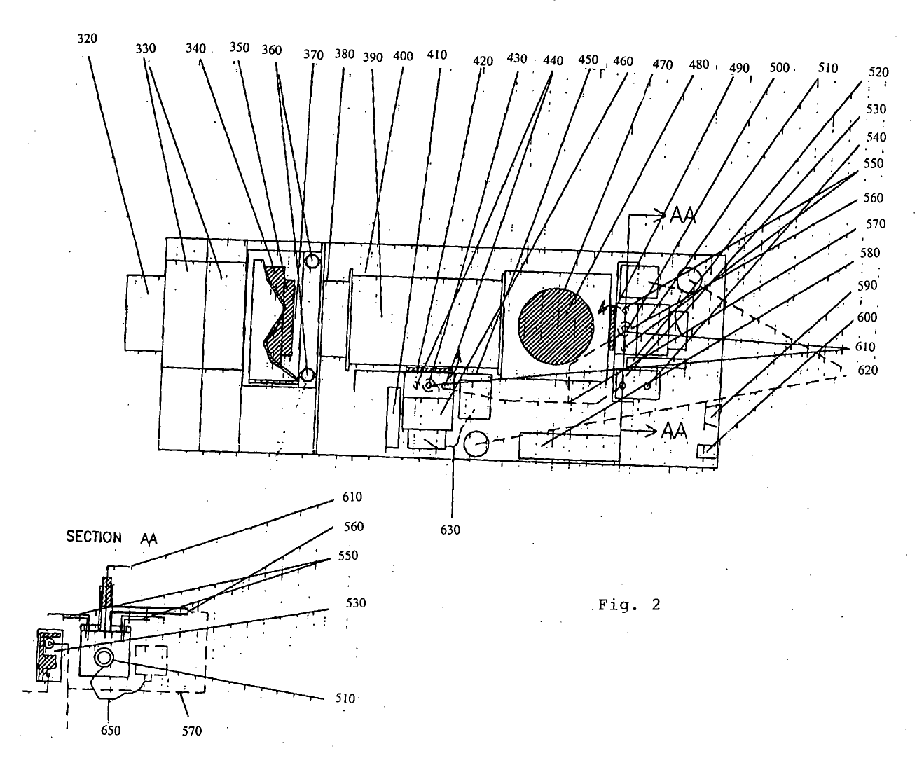

This embodiment is depicted in FIG. 2. The device is powered via AC power input 590 and DC power input 600, and preferably comprises microprocessor 580 to control I/O and switching. Exhaust gas enters cavity 390 via inlet 470 after passing through magnetron field attenuation grid 480, which prevents the microwaves from passing back into the engine. Optionally high temperature exhaust insulation 400 surrounds cavity 390. In cavity 390 the exhaust is exposed to microwave fields from two magnetrons 460, 510 which are powered from back plates 450, 640 via high power line 630, 650 and which preferably couple to cavity 390 via borosilicate hot mirrors 420, 490. Magnetrons 460, 510 are preferably cooled by fans 410, 520. Cooling gas supply pump 530 preferably pumps cold air (or alternatively another gas or fluid) entering pump 530 via inlet 540 through cooling lines 570 to microwave waveguide cooling inputs 500 via antenna input connections 430, 560. This cooling air both cools the microwave antenna and purges NO₂, which is formed in the corona discharge, from the waveguide. The cooling air is then vented into cavity 390, optionally in the directions shown by the arrows in FIG. 2. By using gases other than air for the cooling gas, chemical reactions taking place in cavity 390 can be varied and controlled as desired. The microwave fields are preferably stabilized via field stabilizers 440, 550, preferably comprising spark gaps, which prevent breakdown by limiting the magnitude of the fields in the cavity. The DC field is preferably stabilized using high voltage coils 620. Each magnetron 460, 510 preferably comprises a highly stressed asymmetrical anode 610 to control the corona discharge pulse duration (as described above).

Multiple quartz tubes 360 provide the IR field in cavity 390. The IR field extends without attenuation throughout cavity 390. Preferably, twelve 1500 watt tubes are used, resulting in a field of 18 KVA which is evenly matched to the two 10 KW magnetron tube units which are preferably used in magnetrons 460, 510. Removal connector 380 between the microwave and IR sections of cavity 390 is optionally provided to enable easy maintenance of the device. Particulates in the treated exhaust exiting cavity 390 are preferably deflected by reflector 370 into turbulent flow collector 350 and trapped by particulate trap 340. Reflector 370 also aids in reflecting the IR field back into cavity 390, and may optionally comprise a dielectric, optionally doped with magnetic material, which allows for finer control of the fields in cavity 390 and can optionally create an alternate corona discharge if desired. The treated exhaust preferably passes through thermal expansion/noise attenuation baffles 330 and exits the vehicle through exhaust pipe 320.

### EXAMPLE 1

A preferred embodiment of the present invention for sterilizing building air was tested for contaminant reduction. Concentrations of Methyl Ethyl Ketone (MEK), a highly stable VOC used as a paint solvent, were collected by EPA method 18 and tested in accordance with EPA TO-14 and TO-25A at temperatures not exceeding 112° F. Reductions of 60% of the MEK concentration confirmed the low temperature VOC destruction capabilities of the present invention. E-com KL testing verified 100% reduction of 1870 ppm oil mist (comprising 46 and 68 wt hydraulic oil) contamination of air with a temperature raise from 88° F. of the ambient air to 100° F. for the air discharged from the sterilization cavity. A reduction of 50% of 250 ppm CO at air flow volumes of 14,500 SCFM, and 80% reduction of 10 ppm input NO at 6000 SCFM, with both tests performed below 104° F., were achieved. A typical temperature rise across the system (from the intake air to the air exiting the sterilization cavity) is 12° F. from 88° F. to 100° F. at air flows of 27,000 SCFM. It was estimated that 2° F. of the rise was due to blower compression; 6° F. were attributed to the microwave field; and the remaining 4° F. was due to the IR tuned static field.

### EXAMPLE 2

A preferred embodiment of the present invention for vehicle emissions control was tested for pollutant reduction using a Ford model F-250 truck with a 7.3 liter diesel engine. Pollutant concentrations were continuously monitored according to standard EPA test protocols. The results are summarized in the following table. (Note that CO₂ concentrations were measured in percent, not ppm.)

TABLE 2

| | EPA | | Initial | Final | |
|---|---|---|---|---|---|
| Pollutant | Method | RPM | (ppm) | (ppm) | % Efficiency |
| VOC | 25A | 1000 | 28.30 | 3.83 | 86.5 |
| | | 2000 | 27.22 | 6.59 | 75.8 |
| NOx | 7E | 1000 | 143.15 | 5.43 | 96.2 |
| | | 2000 | 125.98 | 8.57 | 93.2 |
| CO | 10 | 1000 | 362.48 | 0.09 | 99.9 |
| | | 2000 | 279.57 | 0.80 | 99.7 |
| CO₂ | 3A | 1000 | 1.85% | 0.11% | 94.1 |
| | | 2000 | 1.69% | 0.15% | 91.1 |

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. An apparatus for reducing pollutant concentrations in a gas, the apparatus comprising:
a static field generator;
two or more microwave generators; and
a cavity;
wherein a combination of electric fields produced by said microwave generators and said static field generator produces high electric fields in the gas flowing within said cavity.

2. The apparatus of claim 1 wherein said static field generator comprises an infrared generator.

3. The apparatus of claim 2 wherein said infrared generator comprises one or more quartz tubes.

4. The apparatus of claim 3 wherein power provided to each of said tubes is independently controllable.

5. The apparatus of claim 1 wherein a combined field density of between approximately 9 watts per cubic centimeter and approximately 13 watts per cubic centimeter is created in the gas.

6. The apparatus of claim 1 wherein a combined field density of approximately 13 watts per cubic centimeter is created in the gas.

7. The apparatus of claim 1 wherein an electric field having a value of approximately 20 KV/cm is created in the gas.

8. The apparatus of claim 1 wherein said two or more microwave generators comprise magnetrons.

9. The apparatus of claim 1 wherein said two or more microwave generators are situated so that magnetic fields produced by said generators cancel each other out within said cavity.

10. The apparatus of claim 1 wherein said two or more microwave generators comprise field stabilizers.

11. The apparatus of claim 10 wherein each of said field stabilizers comprises at least one spark gap.

12. The apparatus of claim 1 wherein each of said two or more microwave generators comprises an asymmetrical anode.

13. The apparatus of claim 12 wherein said anode controls a Hermstein sheath corona discharge.

14. The apparatus of claim 1 wherein a pollutant in the gas flows through the cavity in no less than approximately six milliseconds.

15. The apparatus of claim 1 wherein the gas comprises air.

16. The apparatus of claim 15 wherein the flow rate of the air through said apparatus is between approximately 27,000 CFM and approximately 250,000 CFM.

17. The apparatus of claim 1 wherein the gas comprises combustion exhaust.

18. The apparatus of claim 17 further comprising a vehicle.

19. The apparatus of claim 18 wherein the exhaust flows through the cavity at substantially the same the exhaust flow rate of the exhaust exiting an exhaust manifold of the vehicle.

20. The apparatus of claim 19 providing a backpressure of less than approximately two inches of water column to the exhaust manifold.

21. A method of reducing pollutant concentrations in a gas, the method comprising the step of applying a static field and two or more microwave fields to the gas.

22. The method of claim 21 wherein the static field comprises an infrared field.

23. The method of claim 21 wherein the applying step comprises creating a combined field density of between approximately 9 watts per cubic centimeter and approximately 13 watts per cubic centimeter in the gas.

24. The method of claim 21 wherein the applying step comprises creating a combined field density of approximately 13 watts per cubic centimeter in the gas.

25. The method of claim 21 wherein the applying step comprises creating an electric field having a value of approximately 20 KV/cm in the gas.

26. The method of claim 21 wherein the applying step comprises canceling out magnetic components of the two or more microwave fields.

27. The method of claim 21 wherein the applying step comprises creating at least one Hermstein sheath corona discharge.

28. The method of claim 21 wherein the applying step comprises applying the fields to a pollutant in the gas for at least approximately six milliseconds.

29. The method of claim 21 wherein the gas comprises air.

30. The method of claim 29 further comprising the step of flowing air through the fields at a flow rate of between approximately 27,000 CFM and approximately 250,000 CFM.

31. The method of claim 21 wherein the gas comprises combustion exhaust.

32. The method of claim 31 further comprising the step of providing a backpressure to the exhaust entering the fields of less than approximately two inches of water column.
